(19) United States
(12) Patent Application Publication
(10) Pub. No.: US 2013/0223319 A1
(43) Pub. Date: Aug. 29, 2013

(54) BROADCAST TRANSMISSION METHOD USING MULTI-ANTENNA TO INCREASE DEGREE OF FREEDOM WITHOUT FEEDBACK OF CHANNEL STATE INFORMATION AND RECEPTION METHOD USING AT LEAST ONE ANTENNA

(71) Applicant: Hee Kwan LEE, Seongnam-si (KR)

(72) Inventor: Hee Kwan LEE, Seongnam-si (KR)

(73) Assignee: Samsung Electronics Co., Ltd., Suwon-si (KR)

(21) Appl. No.: 13/736,293

(22) Filed: Jan. 8, 2013

(30) Foreign Application Priority Data
Feb. 27, 2012 (KR) 10-2012-0019650

(51) Int. Cl. H04W 72/00

(52) U.S. Cl. CPC H04W 72/005
USPC 370/312

(57) ABSTRACT

A broadcast transmission method using a multi-antenna to increase a degree of freedom without feedback of channel state information, and a reception method using at least one antenna, are provided. A communication method of a transmitter in a communication system including the transmitter and at least two receivers, includes selecting complex elements from a channel table to generate a staggered block fading channel between the transmitter and the at least two receivers. The communication method further includes generating a transmission signal based on the selected complex elements. The communication method further includes transmitting the transmission signal to the at least two receivers.

CROSS-REFERENCE TO RELATED APPLICATION(S)

This application claims the benefit under 35 U.S.C. §119(a) of Korean Patent Application No. 10-2012-0019650, filed on Feb. 27, 2012, in the Korean Intellectual Property Office, the entire disclosure of which is incorporated herein by reference for all purposes.

### BACKGROUND

1. Field

The following description relates to a broadcast transmission method using a multi-antenna to increase a degree of freedom without feedback of channel state information, and a reception method using at least one antenna.

2. Description of Related Art

Devices, such as a smartphone and a sensor, may be interconnected through a large network. A large number of devices may transmit and receive contents or data in direct connection with one another, namely, via device-to-device (D2D) communication.

For D2D communication, some changes in multi input multi output (MIMO) schemes may be needed. Various MIMO schemes require sharing of channel state information between a transmitter and a receiver. That is, when sharing of the channel state information is not allowed, a diversity gain, a multiplexing gain, and an increase in a degree of freedom may be difficult to obtain.

However, sharing of the channel state information may cause a great deal of overhead in a D2D communication system. Moreover, such sharing may not be allowed in an ad-hoc network. Accordingly, there is a need for a technology achieving the diversity gain, the multiplexing gain, and the increase in the degree of freedom, without feedback while sharing the channel state information.

### SUMMARY

In one general aspect, there is provided a communication method of a transmitter in a communication system including the transmitter and at least two receivers, the communication method including selecting complex elements from a channel table to generate a staggered block fading channel between the transmitter and the at least two receivers. The communication method further includes generating a transmission signal based on the selected complex elements. The communication method further includes transmitting the transmission signal to the at least two receivers.

The communication method may further include accessing the channel table including a plurality of complex elements, and stored in advance in a memory.

The channel table may include a plurality of complex elements. Each of the plurality of complex elements may include an amplitude of 1.

The channel table may be shared by the transmitter and the at least two receivers.

The communication method may further include determining an inner product between each of the selected complex elements and each of symbols to be transmitted to the at least two receivers. The communication method may further include generating the transmission signal based on the inner product.

The selected complex elements may correspond to respective time slots of the transmission signal if the communication system is a time division multiple access (TDMA) system.

The communication method may further include selecting the complex elements from the channel table based on respective time slots of the transmission signal if the communication system is a time division multiple access (TDMA) system.

The selected complex elements may correspond to respective frequency bands of the transmission signal if the communication system is a frequency division multiple access (FDMA) system.

The selected complex elements may correspond to respective pairs of a time slot and a frequency band of the transmission signal if the communication system is an orthogonal FDMA (OFDMA) system.

The communication method may further include generating the transmission signal without feedback of information on an actual channel between the transmitter and the at least two receivers.

The staggered block fading channel may include a first channel and a second channel between the transmitter and one of the at least two receivers over time. The staggered block fading channel may include a third channel between the transmitter and another one of the at least two receivers over time.

A non-transitory computer-readable storage medium may store a program including instructions to cause a computer to implement the method.

In another general aspect, there is provided a communication method of a receiver in a communication system including a transmitter and at least two receivers, the communication method including receiving a reception signal from a transmitter. The communication method further includes selecting complex elements from a channel table when a staggered block fading channel is between the transmitter and the at least two receivers. The communication method further includes detecting symbols in the received reception signal based on the selected complex elements.

The communication method may further include estimating an actual channel between the transmitter and the at least two receivers. The communication method may further include detecting the symbols in the reception signal based on the estimated actual channel.

The detecting of the symbols may include detecting the symbols based on successive interference cancellation and cancellation of the selected complex elements, in the reception signal.

In still another general aspect, there is provided a transmitter in a communication system including the transmitter and at least two receivers, the transmitter including a memory configured to store a channel table including a plurality of complex elements. The transmitter further includes a processor configured to select complex elements from the channel table to generate a staggered block fading channel between the transmitter and the at least two receivers, and generate a transmission signal to be transmitted to the at least two receivers based on the selected complex elements.

Other features and aspects will be apparent from the following detailed description, the drawings, and the claims.

### BRIEF DESCRIPTION OF THE DRAWINGS

FIG. 1 is a diagram illustrating an example of a communication system including a transmitter and two receivers.

FIG. 2 is a diagram illustrating an example of a staggered block fading channel.

FIG. 3 is a diagram illustrating another example of the staggered block fading channel shown in FIG. 2.

FIG. 4 is a diagram illustrating another example of a staggered block fading channel.

FIG. 5 is a diagram illustrating another example the staggered block fading channel shown in FIG. 4.

FIG. 6 is a diagram illustrating an example of a channel table.

FIG. 7 is a diagram illustrating an example of an N-number of complex elements and an N-number of time slots selected from a channel table in a time division multiple access (TDMA) communication system.

FIG. 8 is a diagram illustrating an example of an N-number of complex elements and an N-number of frequency bands selected from a channel table in a frequency division multiple access (FDMA) communication system.

FIG. 9 is a diagram illustrating an example of an N×N-number of complex elements and an N×N-number of pairs of frequency bands and time slots, selected from a channel table in an orthogonal FDMA (OFDMA) communication system.

FIG. 10 is a flowchart illustrating an example of a communication method of a transmitter.

FIG. 11 is a flowchart illustrating an example of a communication method of a receiver.

FIG. 12 is a diagram illustrating an example of a transmitter and a receiver.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses, and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, description of well-known functions and constructions may be omitted for increased clarity and conciseness.

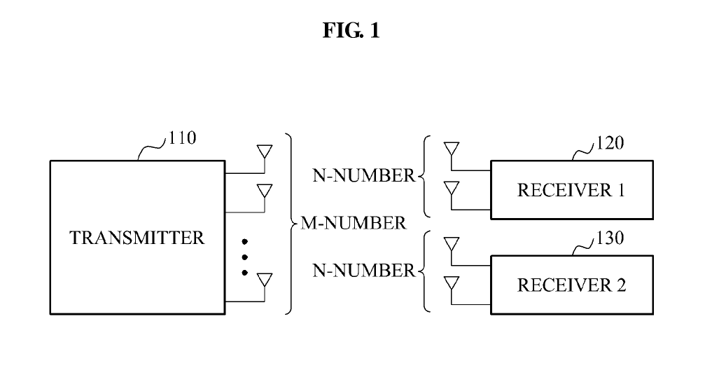

FIG. 1 is a diagram illustrating an example of a communication system including a transmitter and two receivers. Referring to FIG. 1, the communication system includes a transmitter 110, a receiver 1 120, and a receiver 2 130. The transmitter includes an M-number of transmission antennas. Each of the receiver 1 120 and the receiver 2 130 includes an N-number of reception antennas. In another example, the receiver 1 120 and the receiver 2 130 may include different numbers of reception antennas from each other.

In the following description, it is presumed that a number of receivers is two as shown in FIG. 1. It is also presumed that the transmitter 110 includes two transmission antennas, and each of the receiver 1 120 and the receiver 2 130 includes one reception antenna. However, this is only an example, and other numbers of receivers, transmission antennas, and reception antennas may be used, as understood by one of ordinary skill in the art.

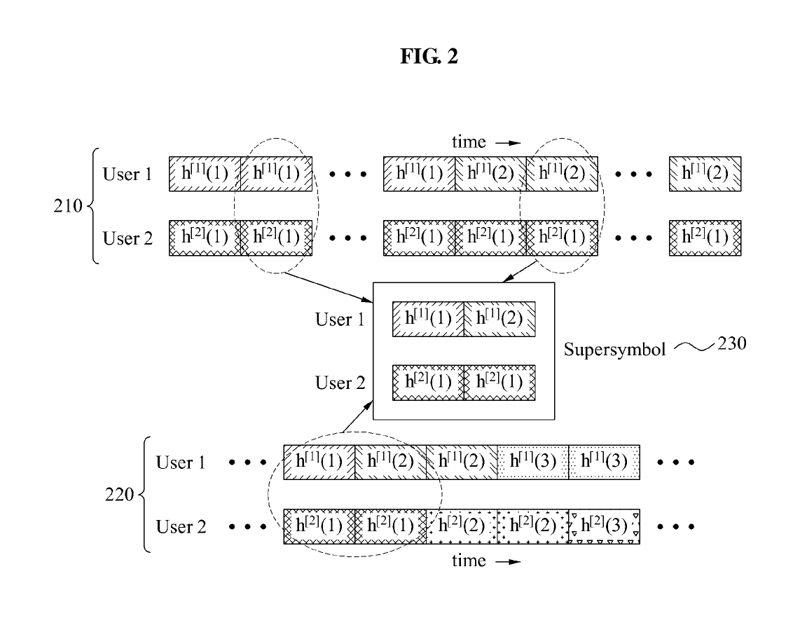

FIG. 2 illustrates an example of a staggered block fading channel. In FIG. 2, h^{[k]}(t) denotes an actual channel between a transmitter and receivers, k denotes a user index, that is, a receiver index, and t denotes a time index. Although FIG. 2 illustrates a time division multiple access (TDMA) communication system, the example of FIG. 2 is also applicable to a frequency division multiple access (FDMA) communication system. In the FDMA communication system, t is replaced by f denoting a frequency band index.

When the channel between the transmitter and the receivers is the staggered block fading channel, symbols for a user 1 and a user 2 (i.e., the receivers) may include fading in a pattern over time as shown in an upper portion 210 of FIG. 2. That is, referring to the upper portion 210, all of the symbols for the user 2 include the same type of fading, such as h^{[2]}(1). However, among the symbols for the user 1, half of the symbols include fading corresponding to h^{[1]}(1), while another half of the symbols includes fading corresponding to h^{[1]}(2). In addition, when the channel between the transmitter and the receivers is the staggered block fading channel, the symbols for the user 1 and the user 2 may include fading in a pattern over time as shown in a lower portion 220 of FIG. 2.

If the symbols for the user 1 and the user 2 include the fading in the patterns shown in the upper portion 210 and/or the lower portion 220, an effective channel between the transmitter and the receivers may be referred to as the staggered block fading channel. The staggered block fading channel may be expressed as a supersymbol 230 shown in a center of FIG. 2. That is, in the supersymbol 230 in which the symbols for the user 1 include symbols A and B, and the symbols for the user 2 include symbols C and D, the symbol A includes the fading corresponding to h^{[1]}(1), the symbol B includes the fading corresponding to and the symbols C and D include the fading corresponding to h^{[2]}(1).

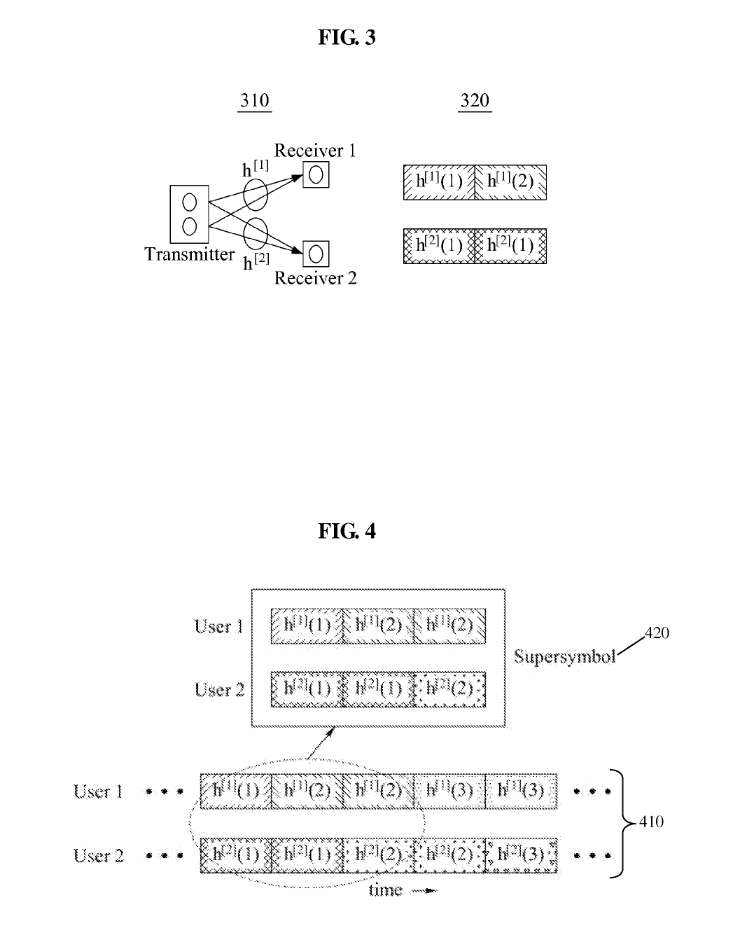

FIG. 3 illustrates another example of the staggered block fading channel shown in FIG. 2. Referring to a left portion 310 of FIG. 3, h^{[1]} denotes an actual channel between a transmitter and a receiver 1, and h^{[2]} denotes an actual channel between the transmitter and a receiver 2. When an effective channel between the transmitter and the receivers is the staggered block fading channel, a supersymbol may be expressed as shown in a right portion 320 of FIG. 3, which corresponds to the supersymbol 230 of FIG. 2. That is, in the staggered block fading channel, symbols for the receiver 1 and the receiver 2 may include fading in a pattern as shown in the upper portion 210 and/or the lower portion 220 of FIG. 2.

FIG. 4 illustrates another example of a staggered block fading channel. When symbols for a user 1 and a user 2 (e.g., receivers) include fading in a pattern over time as shown in a lower portion 410 of FIG. 4, an effective channel between a transmitter and the receivers may be referred to as the staggered block fading channel. In this example, the staggered block fading channel between the transmitter and the receivers may be expressed as a supersymbol shown in an upper portion 420 of FIG. 4. That is, in the supersymbol shown in the upper portion 420 in which the symbols for the user 1 include symbols A, B, and C, and the symbols for the user 2 include symbols D, E, and F, the symbol A includes the fading corresponding to h^{[1]}(1), the symbols B and C include the fading corresponding to h^{[1]}(2), the symbols C and D include the fading corresponding to h^{[2]}(1), and the symbol E includes the fading corresponding to h^{[2]}(2).

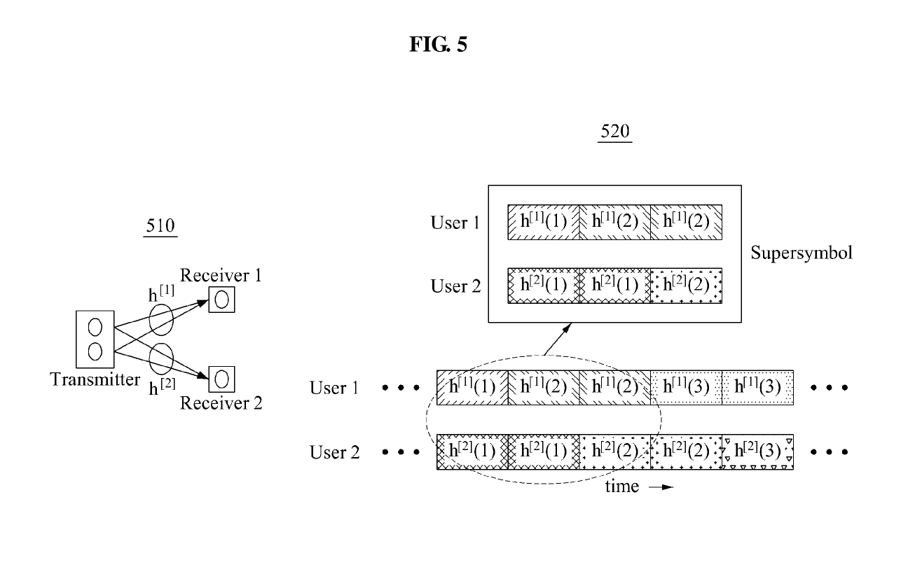

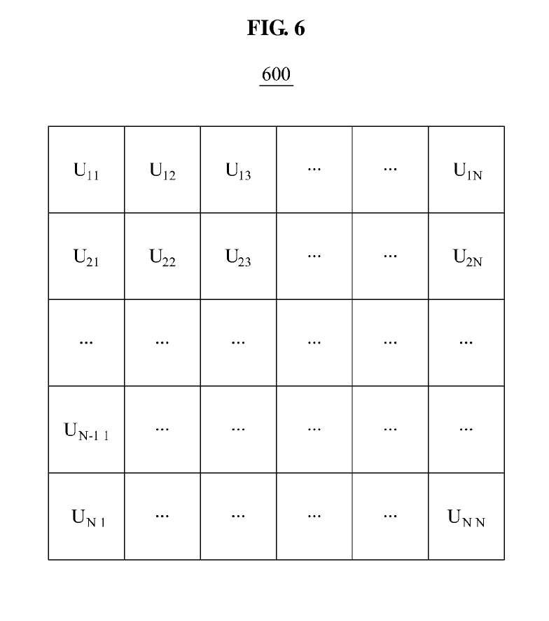

FIG. 5 illustrates another example of the staggered block fading channel shown in FIG. 4. Referring to a left portion 510 of FIG. 5, h^{[1]} denotes an actual channel between a transmitter and a receiver 1, and h^{[2]} denotes an actual channel between the transmitter and a receiver 2. When an effective channel between the transmitter and the receivers is the staggered block fading channel, a supersymbol may be expressed as shown in a right portion 520 of FIG. 5, which corresponds to the supersymbol shown in the upper portion 420 of FIG. 4. That is, in the staggered block fading channel, the symbols for the receiver 1 and the receiver 2 may include fading in a pattern as shown in the right portion 520 of FIG. 5, which corresponds to the lower portion 410 of FIG. 4.

When Gaussian noise terms are omitted, reception signals y of the receiver 1 and the receiver 2 in the staggered block fading channel may be respectively expressed by the examples of Equation 1.

$$[ \begin{matrix}{y}^{[ 1 ]} ( 1 ) \\ {y}^{[ 1 ]} ( 2 )\end{matrix} ] = [ \begin{matrix}{h}_{1}^{[ 1 ]} ( 1 ) & {h}_{2}^{[ 1 ]} ( 1 ) & 0 & 0 \\ 0 & 0 & {h}_{1}^{[ 1 ]} ( 2 ) & {h}_{2}^{[ 1 ]} ( 2 )\end{matrix} ] [ \begin{matrix}{x}_{1} ( 1 ) \\ {x}_{2} ( 1 ) \\ {x}_{1} ( 2 ) \\ {x}_{2} ( 2 )\end{matrix} ] \\ [ \begin{matrix}{y}^{[ 2 ]} ( 1 ) \\ {y}^{[ 2 ]} ( 2 )\end{matrix} ] = [ \begin{matrix}{h}_{1}^{[ 2 ]} ( 1 ) & {h}_{2}^{[ 2 ]} ( 1 ) & 0 & 0 \\ 0 & 0 & {h}_{1}^{[ 2 ]} ( 1 ) & {h}_{2}^{[ 2 ]} ( 1 )\end{matrix} ] [ \begin{matrix}{x}_{1} ( 1 ) \\ {x}_{2} ( 1 ) \\ {x}_{1} ( 2 ) \\ {x}_{2} ( 2 )\end{matrix} ] \qquad [ Equation 1 ]$$

In Equation 1, in a reception signal y^{[k]}(t), [k] denotes a user index, that is, a receiver index, and (t) denotes a time index. h^{[1]}=[h₁^{[1]}h₂^{[1]}] is satisfied, and the actual channel h^{[2]} is defined in the same manner. In an actual channel hₘ^{[k]}, m denotes a transmission antenna index. Also, xₘ(t) denotes a transmission signal of the transmitter that corresponds to an m-th transmission antenna and a time t.

Based on Equation 1, reception matrices Y with respect to the reception signals of the receiver 1 and the receiver 2 may be expressed by the examples of Equation 2, including Gaussian noise matrices Z with respect to Gaussian noise terms z of the receiver 1 and the receiver 2, respectively.

Y^{[1]}=H^{[1]}X+Z^{[1]}

Y^{[2]}=H^{[2]}X+Z^{[2]} [Equation 2]

In Equation 2, H^{[k]} denotes a channel matrix with respect to an actual channel between the transmitter and a receiver k. A transmission matrix X with respect to transmission signals of the transmitter for symbols u to include fading of the staggered block fading channel may be expressed by the example of Equation 3.

$$X = [ \begin{matrix}1 & 0 \\ 0 & 1 \\ 1 & 0 \\ 0 & 1 \\ 0 & 0 \\ 0 & 0\end{matrix} ] [ \begin{matrix}{u}_{1}^{[ 1 ]} \\ {u}_{2}^{[ 1 ]}\end{matrix} ] + [ \begin{matrix}0 & 0 \\ 0 & 0 \\ 1 & 0 \\ 0 & 1 \\ 1 & 0 \\ 0 & 1\end{matrix} ] [ \begin{matrix}{u}_{1}^{[ 2 ]} \\ {u}_{2}^{[ 2 ]}\end{matrix} ] \qquad [ Equation 3 ]$$

In Equation 3, uₘ^{[k]} denotes a symbol corresponding to the m-th transmission antenna, and an k-th user. That is, when the transmission matrix X is generated as shown in Equation 3, the symbol uₘ^{[k]} includes the fading of the staggered block fading channel. When channel state information with respect to the actual channel between the transmitter and the receiver 1 is shared between the transmitter and the receiver 1, the staggered block fading channel may be produced by generating the transmission matrix X in the manner as expressed by the example of Equation 4.

$$X = [ \begin{matrix}1 & 0 \\ 0 & 1 \\ 1 & 0 \\ 0 & 1\end{matrix} ] [ \begin{matrix}{u}_{1}^{[ 1 ]} \\ {u}_{2}^{[ 1 ]}\end{matrix} ] + [ \begin{matrix}{h}_{2}^{[ 1 ]} ( 1 ) \\ - {h}_{1}^{[ 1 ]} ( 1 ) \\ 0 \\ 0\end{matrix} ] {u}^{[ 2 ]} \qquad [ Equation 4 ]$$

FIG. 6 illustrates an example of a channel table. The channel table, that is, a unitary channel table 600, may be stored in advance in a memory of each of a transmitter and at least two receivers. That is, the transmitter selects complex elements from a plurality of complex elements included in the channel table 600 to generate transmission signals to be transmitted to the receivers, so that an effective channel between the transmitter and the receivers is a staggered block fading channel. The transmitter makes or generates the effective channel into the staggered block fading channel based on the channel table 600 even without feedback of channel state information between the transmitter and the receivers. Furthermore, since the receivers are aware of the channel table 600 used by the transmitter, and are aware of the complex elements selected by the transmitter for the generation of the transmission signals, the receivers detect desired symbols based on reception signals (i.e., the transmission signals) received from the transmitter.

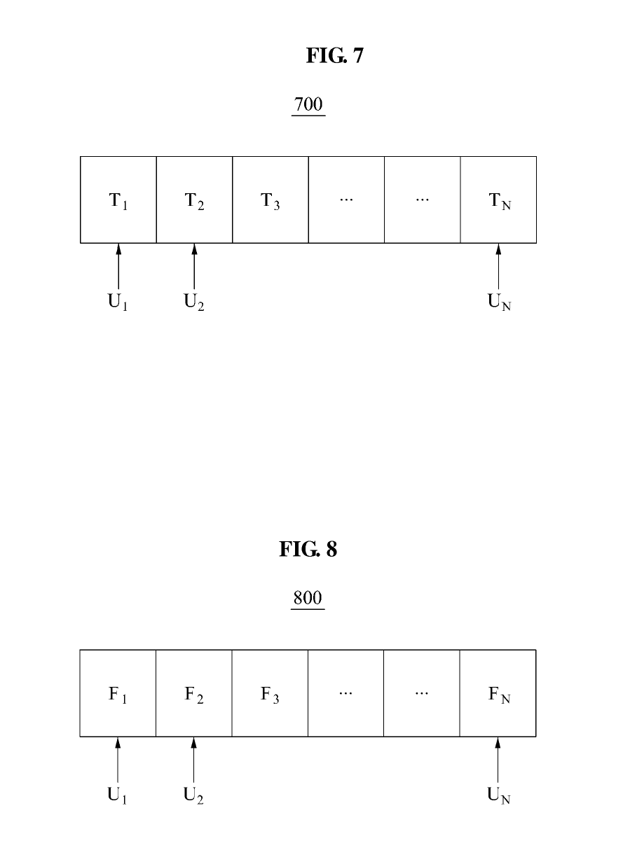

In more detail, the channel table 600 includes a plurality of complex elements U, each of which includes an amplitude of about 1. For example, one complex element may be 0.6+0.8j. As aforementioned, the channel table 600 may be shared by the transmitter and the receivers and used for the generation of the staggered block fading channel. In further detail, to generate the staggered block fading channel, the transmitter determines an inner product between each of the selected complex elements and each of respective symbols to be transmitted to the receivers, and generates a transmission signal to be transmitted to the receivers based on the inner product. As will be described once again with reference to FIGS. 7-9, the channel table 600 may be applied to any of TDMA, FDMA, and orthogonal FDMA (OFDMA) systems.

FIG. 7 illustrates an example of an N-number of complex elements U and an N-number of time slots T selected from a channel table in a TDMA communication system. Referring to a diagram 700 of FIG. 7, the TDMA communication system uses the N-number of the time slots T to transfer signals. A length tₖ of one time slot may correspond to a symbol duration.

All tₖ values may correspond to the respective selected complex elements U among a plurality of complex elements included in the channel table. That is, the selected complex elements U are respectively selected in the time slots T of a signal. The foregoing operation may be cyclically performed based on a time period.

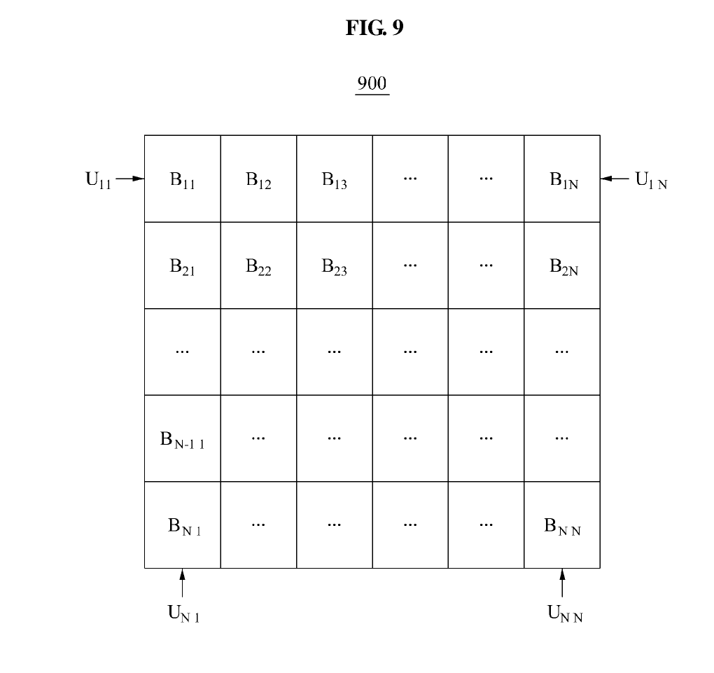

FIG. 8 illustrates an example of an N-number of complex elements U and an N-number of frequency bands F selected from a channel table in an FDMA communication system. Referring to a diagram 800 of FIG. 8, the FDMA communication system uses the N-number of the frequency bands F to transfer signals.

All frequency Fₖ values of the respective frequency bands F may correspond to the respective selected complex elements U among a plurality of complex elements included in the channel table. That is, the selected complex elements U are respectively selected in the frequency bands F of a signal.

FIG. 9 illustrates an example of an N×N-number of complex elements U and an N×N-number of pairs B of frequency bands and time slots, selected from a channel table in an OFDMA communication system. Referring to a diagram 900 of FIG. 9, the OFDMA communication system uses the N×N number of the pairs B of the frequency bands and the time slots to transfer signals. That is, the OFDMA communication system is a combination of an TDMA communication system and an FDMA communication system.

The pairs B of the frequency bands and the time slots correspond to the respective selected complex elements U among a plurality of complex elements included in the channel table. That is, the selected complex elements U are respectively selected in the time slots T and in the frequency bands F of a signal.

To summarize the foregoing description, the transmitter artificially generates the staggered block fading channel based on the channel table of FIG. 6. A transmission matrix X with respect to transmission signals signal generated by the transmitter may be expressed by the example of Equation 5.

$$X = ( \begin{matrix}1 & 0 \\ 0 & 1 \\ 1 & 0 \\ 0 & 1 \\ 0 & 0 \\ 0 & 0\end{matrix} ) \times {U}_{11} \times ( \begin{matrix}{u}_{1}^{[ 1 ]} \\ {u}_{2}^{[ 1 ]}\end{matrix} ) + ( \begin{matrix}0 & 0 \\ 0 & 0 \\ 1 & 0 \\ 0 & 1 \\ 1 & 0 \\ 0 & 1\end{matrix} ) \times {U}_{12} \times ( \begin{matrix}{u}_{1}^{[ 2 ]} \\ {u}_{2}^{[ 2 ]}\end{matrix} ) \qquad [ Equation 5 ]$$

In Equation 5, complex elements U₁₁ and U₁₂ may be selected from the channel table based on corresponding time slots and/or frequency bands of the transmission signals.

When a receiver receives a transmission signal generated based on Equation 5, the receiver detects desired symbols in a reception signal (i.e., a transmission signal) based on a reception method. For example, the receiver may estimate an actual channel between the transmitter and the receiver based on a preamble or pilot signals transmitted from the transmitter. In addition, since the complex elements corresponding to the time slots and/or the frequency bands predetermined by the channel table are used by the transmitter to generate the transmission signal, the receiver recognizes the complex elements based on the channel table and the corresponding time slot and/or frequency band of the reception signal.

Reception signals y received by the receiver 1 may be expressed by the examples of Equation 6.

$$( \begin{matrix}{y}^{[ 1 ]} ( 1 ) \\ {y}^{[ 1 ]} ( 2 ) \\ {y}^{[ 1 ]} ( 3 )\end{matrix} ) = ( \begin{matrix}{h}_{1}^{[ 1 ]} ( 1 ) & {h}_{2}^{[ 1 ]} ( 1 ) & 0 & 0 & 0 & 0 \\ 0 & 0 & {h}_{1}^{[ 1 ]} ( 2 ) & {h}_{2}^{[ 1 ]} ( 2 ) & 0 & 0 \\ 0 & 0 & 0 & 0 & {h}_{1}^{[ 1 ]} ( 2 ) & {h}_{2}^{[ 1 ]} ( 2 )\end{matrix} ) \times ( \begin{matrix}{x}_{1} ( 1 ) \\ {x}_{2} ( 1 ) \\ {x}_{1} ( 2 ) \\ {x}_{2} ( 2 ) \\ {x}_{1} ( 3 ) \\ {x}_{2} ( 3 )\end{matrix} ) + ( \begin{matrix}{z}^{[ 1 ]} ( 1 ) \\ {z}^{[ 1 ]} ( 2 ) \\ {z}^{[ 1 ]} ( 3 )\end{matrix} ) \qquad [ Equation 6 ]$$

Reception signals y received by the receiver 2 may be expressed by the examples of Equation 7.

$$( \begin{matrix}{y}^{[ 2 ]} ( 1 ) \\ {y}^{[ 2 ]} ( 2 ) \\ {y}^{[ 2 ]} ( 3 )\end{matrix} ) = ( \begin{matrix}{h}_{1}^{[ 2 ]} ( 1 ) & {h}_{2}^{[ 2 ]} ( 1 ) & 0 & 0 & 0 & 0 \\ 0 & 0 & {h}_{1}^{[ 2 ]} ( 2 ) & {h}_{2}^{[ 2 ]} ( 2 ) & 0 & 0 \\ 0 & 0 & 0 & 0 & {h}_{1}^{[ 2 ]} ( 2 ) & {h}_{2}^{[ 2 ]} ( 2 )\end{matrix} ) \times ( \begin{matrix}{x}_{1} ( 1 ) \\ {x}_{2} ( 1 ) \\ {x}_{1} ( 2 ) \\ {x}_{2} ( 2 ) \\ {x}_{1} ( 3 ) \\ {x}_{2} ( 3 )\end{matrix} ) + ( \begin{matrix}{z}^{[ 2 ]} ( 1 ) \\ {z}^{[ 2 ]} ( 2 ) \\ {z}^{[ 2 ]} ( 3 )\end{matrix} ) \qquad [ Equation 7 ]$$

Equation 6 may also be expressed by the examples of Equation 8.

$$( \begin{matrix}{y}^{[ 1 ]} ( 1 ) \\ {y}^{[ 1 ]} ( 2 ) \\ {y}^{[ 1 ]} ( 3 )\end{matrix} ) = {U}_{11} \times ( \begin{matrix}{h}_{1}^{[ 1 ]} ( 1 ) & {h}_{2}^{[ 1 ]} ( 1 ) \\ {h}_{1}^{[ 1 ]} ( 2 ) & {h}_{2}^{[ 1 ]} ( 2 ) \\ 0 & 0\end{matrix} ) \times ( \begin{matrix}{u}_{1}^{[ 1 ]} \\ {u}_{2}^{[ 1 ]}\end{matrix} ) + {U}_{12} \times ( \begin{matrix}0 \\ 1 \\ 1\end{matrix} ) \times ( {h}_{1}^{[ 1 ]} ( 2 ) {u}_{1}^{[ 2 ]} + {h}_{2}^{[ 1 ]} ( 2 ) {u}_{2}^{[ 2 ]} ) + ( \begin{matrix}{z}^{[ 1 ]} ( 1 ) \\ {z}^{[ 1 ]} ( 2 ) \\ {z}^{[ 1 ]} ( 3 )\end{matrix} ) \qquad [ Equation 8 ]$$

The receiver 1 may perform the detection based on successive interference cancellation. For example, the receiver 1 may detect reception signals y^{[1]}(1), y^{[1]}(2), and y^{[1]}(3) in sequence. In addition, the receiver 1 may determine y^{[1]}(2)−y^{[1]}(3), thereby concluding h₁^{[1]}(2)u₁^{[1]}+h₂^{[1]}(2)u₂^{[1]}+z^{[1]}(2)−z^{[1]}(3).

Since U₁₁ and U₁₂ are shared by both the transmitter and the receivers, cancellation of U₁₁ and U₁₂ is possible. Accordingly, the receiver 1 may detect the desired symbols using channel coefficients of the estimated channel. Also, the receiver 2 may detect desired symbols in a manner similar to that of the receiver 1.

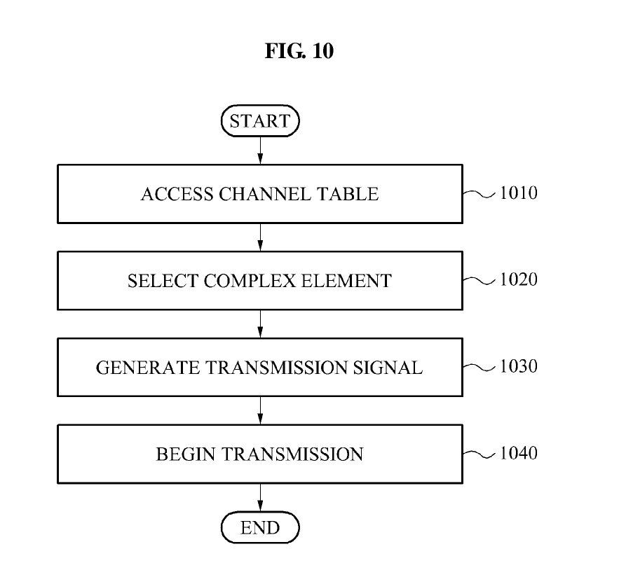

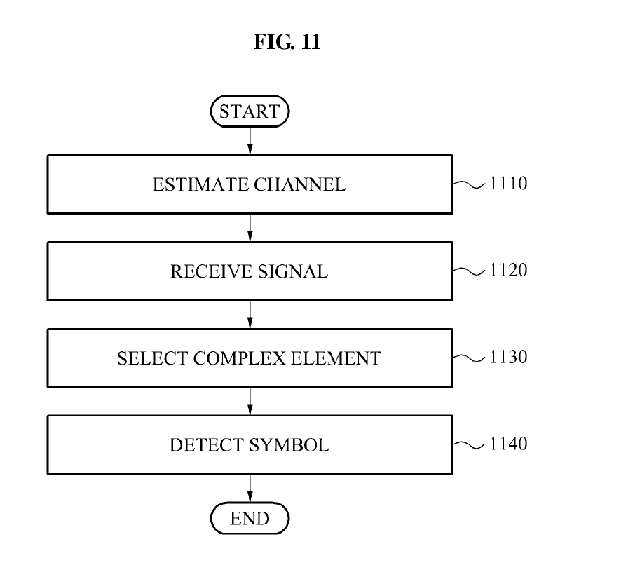

FIG. 10 illustrates an example of a communication method of a transmitter. In a communication system including the transmitter and at least two receivers, in operation 1010, the transmitter accesses a channel table including a plurality of complex elements stored in advance in a memory.

In operation 1020, the transmitter selects complex elements from the plurality of complex elements so that an effective channel between the transmitter and the receivers is a staggered block fading channel. For example, the complex elements may be selected from the channel table based on corresponding time slots and/or frequency bands of a transmission signal to be transmitted to the receivers. In operation 1030, the transmitter generates the transmission signal based on the selected complex elements and respective symbols.

In operation 1040, the transmitter begins transmission of the transmission signal to the receivers. The communication method of the transmitter described above in detail with reference to FIGS. 1 through 9 may be applied to the transmitter of FIG. 10, and thus, a repeated description will be omitted.

FIG. 11 illustrates an example of a communication method of a receiver. In a communication system including a transmitter and at least two receivers, in operation 1110, the receiver estimates an actual channel between the transmitter and the receivers.

In operation 1120, the receiver receives a reception signal (i.e., a transmission signal) from the transmitter. In operation 1130, when an effective channel between the transmitter and the receivers is a staggered block fading channel, the receiver accesses a channel table including a plurality of complex elements stored in advance in a memory, and selects complex elements from the plurality of complex elements. For example, the complex elements may be selected from the channel table based on corresponding time slots and/or frequency bands of the received reception signal. In operation 1140, the transmitter transmitter detects desired symbols in the received reception signal based on the estimated channel and the selected complex elements.

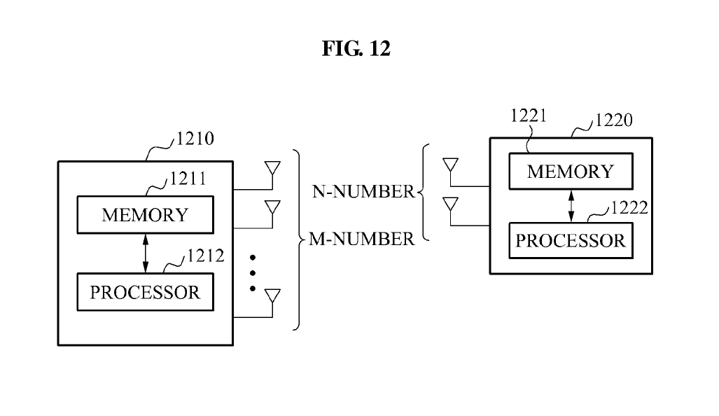

FIG. 12 is a diagram illustrating an example of a transmitter 1210 and a receiver 1220. Referring to FIG. 12, the transmitter 1210 includes a memory 1211 and a processor 1212, while the receiver 1220 includes a memory 1221 and a processor 1222.

Each of the memories 1211 and 1221 stores an identical channel table including a plurality of complex elements. The processor 1212 selects complex elements from the plurality of complex elements so that an effective channel between the transmitter 1210 and the receiver 1220 is a staggered block fading channel. In addition, the processor 1212 generates a transmission signal based on the selected complex elements and respective symbols. The transmitter 1210 broadcasts the transmission signal through an M-number of transmission antennas.

The receiver 1220 receives a reception signal (i.e., the transmission signal) from the transmitter 1210 through an N-number of reception antennas. The processor 1222 estimates an actual channel between the transmitter 1210 and the receiver 1220, and selects complex elements from the plurality of complex elements. The processor 1222 detects desired symbols in the received reception signal based on the estimated channel and the selected complex elements.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of non-transitory computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files including higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments accomplishing the examples disclosed herein can be easily construed by programmers skilled in the art to which the examples pertain based on and using the flow diagrams and block diagrams of the figures and their corresponding descriptions as provided herein.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of a transmitter in a communication system comprising the transmitter and at least two receivers, the communication method comprising:
selecting complex elements from a channel table to generate a staggered block fading channel between the transmitter and the at least two receivers;
generating a transmission signal based on the selected complex elements; and
transmitting the transmission signal to the at least two receivers.

2. The communication method of claim 1, further comprising:
accessing the channel table comprising a plurality of complex elements, and stored in advance in a memory.

3. The communication method of claim 1, wherein:
the channel table comprises a plurality of complex elements; and
each of the plurality of complex elements comprises an amplitude of 1.

4. The communication method of claim 1, wherein:
the channel table is shared by the transmitter and the at least two receivers.

5. The communication method of claim 1, further comprising:
determining an inner product between each of the selected complex elements and each of symbols to be transmitted to the at least two receivers; and
generating the transmission signal based on the inner product.

6. The communication method of claim 1, wherein:
the selected complex elements correspond to respective time slots of the transmission signal if the communication system is a time division multiple access (TDMA) system.

7. The communication method of claim 1, further comprising:
selecting the complex elements from the channel table based on respective time slots of the transmission signal if the communication system is a time division multiple access (TDMA) system.

8. The communication method of claim 1, wherein:
the selected complex elements correspond to respective frequency bands of the transmission signal if the communication system is a frequency division multiple access (FDMA) system.

9. The communication method of claim 1, wherein:
the selected complex elements correspond to respective pairs of a time slot and a frequency band of the transmission signal if the communication system is an orthogonal FDMA (OFDMA) system.

10. The communication method of claim 1, further comprising:
generating the transmission signal without feedback of information on an actual channel between the transmitter and the at least two receivers.

11. The communication method of claim 1, wherein the staggered block fading channel comprises:
a first channel and a second channel between the transmitter and one of the at least two receivers over time; and
a third channel between the transmitter and another one of the at least two receivers over time.

12. A non-transitory computer-readable storage medium storing a program comprising instructions to cause a computer to implement the method of claim 1.

13. A communication method of a receiver in a communication system comprising a transmitter and at least two receivers, the communication method comprising:
receiving a reception signal from a transmitter;
selecting complex elements from a channel table when a staggered block fading channel is between the transmitter and the at least two receivers; and
detecting symbols in the received reception signal based on the selected complex elements.

14. The communication method of claim 13, further comprising:
accessing the channel table comprising a plurality of complex elements, and stored in advance in a memory.

15. The communication method of claim 13, further comprising:
estimating an actual channel between the transmitter and the at least two receivers; and
detecting the symbols in the reception signal based on the estimated actual channel.

16. The communication method of claim 13, wherein:
the channel table comprises a plurality of complex elements; and
each of the plurality of complex elements comprises an amplitude of 1.

17. The communication method of claim 13, wherein:
the selected complex elements correspond to respective time slots of the reception signal if the communication system is a time division multiple access (TDMA) system; and
the detecting of the symbols comprises detecting the symbols based on successive interference cancellation and cancellation of the selected complex elements, in the reception signal.

18. The communication method of claim 13, wherein:
the selected complex elements correspond to respective frequency bands of the reception signal if the communication system is a frequency division multiple access (FDMA) system; and
the detecting of the symbols comprises detecting the symbols based on successive interference cancellation and cancellation of the selected complex elements, in the reception signal.

19. The communication method of claim 13, wherein:
the selected complex elements correspond to respective pairs of a time slot and a frequency band of the reception signal if the communication system is an orthogonal FDMA (OFDMA) system; and
the detecting of the symbols comprises detecting the symbols based on successive interference cancellation and cancellation of the selected complex elements, in the reception signal.

20. A transmitter in a communication system comprising the transmitter and at least two receivers, the transmitter comprising:
a memory configured to store a channel table comprising a plurality of complex elements; and
a processor configured to
select complex elements from the channel table to generate a staggered block fading channel between the transmitter and the at least two receivers, and
generate a transmission signal to be transmitted to the at least two receivers based on the selected complex elements.
